(19) United States
(12) Patent Application Publication
(10) Pub. No.: US 2009/0171058 A1
(43) Pub. Date: Jul. 2, 2009

(54) Low temperature platinum-vinylpolysiloxane hydrosilylation catalyst

(76) Inventor: John Kilgour, Clifton Park, NY (US)

Correspondence Address: MOMENTIVE PERFORMANCE MATERIALS INC.;c/o Dilworth & Barrese, LLP, 1000 Woodbury Road, Suite 405, Woodbury, NY, 11797, US

(21) Appl. No.: 12/006,171

(22) Filed: Dec. 31, 2007

(51) Int. Cl. C08G 77/20

(52) U.S. Cl. 528/32

(57) ABSTRACT

Hydrosilation catalysts are provided in the form of platinum-MQ siloxanes. The platinum-MQ siloxane catalyst can be made directly from platinum-complexes containing at least one ligand and the desired MQ siloxane resin. The platinum-MQ siloxane catalyst can be employed as hydrosilation catalysts to make curable organopolysiloxane compositions.

### FIELD OF THE INVENTION

The present invention relates to platinum-vinylpolysiloxane catalysts, methods for making them and to their use as hydrosilylation catalysts.

### BACKGROUND OF THE INVENTION

Hydrosilylation is a reaction in which silicon-bonded hydrogen adds across an aliphatically unsaturated carbon-carbon bond under catalysis by a hydrosilylation catalyst such as chloroplatinic acid, platinum-alkenylsiloxane complexes, and platinum-olefin complexes.

Carbon-silicon bonds can be easily generated by this reaction, and as a consequence, it has found use in reactions for the synthesis of a variety of organosilanes, silicon-containing organic compounds, and organopolysiloxanes. It is also employed as a crosslinking reaction for curable organopolysiloxane compositions.

The paper release coating industry is based on rapidly coating a wide variety of substrates such as paper, polyester (PET), polyethylene (PE), polypropylene (PP), or polyethylene coated Kraft paper (PEK). The substrates once coated with silicone posses an inert surface that provides a low release value for a variety of adhesive layers used for making labels, stickers and the like. Thus, the silicone coated substrate is either coated with a pressure sensitive adhesive followed by the desired label stock, or it is mated with an adhesive coated label stock such that the silicone coated substrate (siliconized liner) protects the adhesive layer until it reaches the desired application.

The most efficient process for preparing the silicone-coated substrate is by first coating the substrate with a very thin layer of a liquid silicone solution containing no solvent. The substrate is then heated to cause polymerization of the silicone solution to form a silicone polymer anchored to the substrate. The most efficient chemistry currently employed requires the platinum catalyzed hydrosilylation of a vinyl siloxane and hydridosiloxane, both containing two or more of their respective functional groups such that a crosslinked silicone polymer is produced. Currently the standard hydrosilylation catalyst of choice for rapid reactions is Karstedt's catalyst (Pt₂[CH₂═CHSi(CH₃)₂—O—Si(CH₃)₂CH═CH₂]₃).

Although many types of paper and films such as PET have been coated in this manner, the process requires considerable heat and high levels of catalyst to reach completion in the time allotted to be commercially acceptable. Thus, typical temperatures reach 150° C. and platinum levels may be 100 ppm or higher depending on the temperature and time allowed for curing. As such, the highly desirable, temperature sensitive substrates (for example those with a glass transition temperature, i.e., Tg of less than 120° C.) such as PE, PP, and PEK are difficult or very expensive to coat.

The crosslinkable silicone release compositions of the present invention gain further advantage in coating substrates that would benefit from coating at lower temperatures. Thus for example, Super Calendared Kraft paper (SCK) paper is currently coated at 150° C., where the high temperature causes excessive drying of the paper. Under atmospheric conditions the paper absorbs water and curls. The curling creates problems with later label attachment and label processing. Currently the industry requires a “rewetting” process with steam to prevent curling. Thus low temperature curing (for example, less than 100° C.) reduces the initial drying and obviates the need for “rewetting” to obtain flat silicone coated SCK liners.

Similarly, both paper and films with high Tg's can gain advantage using low temperature cure formulations if the energy required for curing is lower. Recently there have been significant increases in the prices of both the energy needed to provide the required cure temperature, and for the platinum used in preparing the catalyst. A platinum catalyst is needed that meets the curing requirements of the silicone polymer at low temperatures, i.e., below 120° C., and low platinum levels, i.e., less than 100 ppm.

Thus, within the industry there is need for a low cost platinum catalyst capable of effecting rapid cure at low temperatures. One such application is in the release coating industry. Surprisingly, the present inventors have discovered that a novel platinum catalyst containing a new silicone ligand provides these low cost and rapid cure features.

### SUMMARY IF THE INVENTION

According to an embodiment of the invention, a platinum containing hydrosilylation catalyst is provided comprising at least one monosiloxy unit possessing carbon-carbon double bond functionality and at least one tetrasiloxy unit.

According to another embodiment of the invention, a platinum containing hydrosilylation catalyst composition is prepared by the process comprising:
i) mixing at least one platinum-complex containing at least one ligand which is substantially absent of tetrasiloxy units, and a polyorganosiloxane resin containing at least one monosiloxy unit possessing carbon-carbon double bond functionality and at least one tetrasiloxy unit; and
ii) exchanging a ligand of the platinum-complex containing at least one ligand with the polyorganosiloxane resin under exchange conditions to provide said platinum containing hydrosilylation catalyst.

The novel catalyst reduces the effective temperature for performing hydrosilylation reactions, reduces the amount of catalyst needed to have the reaction reach completion at low temperatures and provides for faster and more efficient hydrosilylation at low temperature. The novel catalyst is particularly effective in providing a thermally cured and solventless silicone release coating on temperature sensitive supports and films.

### DETAILED DESCRIPTION OF THE INVENTION

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range and any combination of the various endpoints of such ranges or subranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

This new catalyst provides for faster and more efficient hydrosilylation at low temperature. As a result, it is possible to coat temperature sensitive film, such as, for example, polyethylene, polypropylene, polypropylene coated Kraft paper (PPK), polyethylene coated Kraft paper (PEK), and multilayer laminate films containing temperature sensitive components, using a thermally cured and solventless silicone formulation.

According to an embodiment of the invention, a platinum containing hydrosilylation catalyst is provided comprising at least one monosiloxy unit possessing carbon-carbon double bond functionality and at least one tetrasiloxy unit. Accordingly, the present hydrosilylation catalyst comprises a compound having the Formula (1):

Pt_{f}(MₐM^{vi}_{b}Q_{c})_{g} (1)

wherein:
each occurrence of M is independently selected from the group consisting of R¹₃ SiO_{1/2}, HO_{1/2}, and R¹_{1/2} and wherein each occurrence of R¹ is independently a monovalent hydrocarbon group containing from 1 to 30 carbon atoms;

each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;

each occurrence of Q is independently SiO_{4/2};

each occurrence of the subscripts a, b, c, f, g and x is independently an integer wherein a is 0 to 200; b is 1 to 202; c is 1 to 100; f is 1 to 100; g is 1 to 150; and x is 1 to 3.

According to another embodiment of the invention, each occurrence of M is independently R¹₃ SiO_{1/2}, wherein each occurrence of R¹ is a monovalent hydrocarbon group containing specifically from 1 to 20 carbon atoms, more specifically from 1 to 6 carbon atoms and most specifically, 1 carbon atom; R² is a monovalent hydrocarbon group containing specifically from 1 to 20 carbon atoms possessing at least one terminal carbon-carbon double bond, more specifically from 1 to 6 carbon atoms possessing at least one terminal carbon-carbon double bond and most specifically, 2 carbon atoms bonded to each other through a carbon-carbon double bond; R³ is a monovalent hydrocarbon group containing specifically from 1 to 20 carbon atoms, more specifically from 1 to 6 carbon atoms and most specifically, 1 carbon atom; a is specifically from 0 to 50, more specifically from 0 to 10, and most specifically 0; b is specifically from 1 to 50, more specifically from 2 to 15, and most specifically from 3 to 10; c is specifically from 1 to 50, more specifically from 2 to 10, and most specifically 3 to 5; f is specifically from 1 to 10, more specifically from 1 to 2, and most specifically 1; g is specifically from 1 to 20, more specifically from 1 to 4, and most specifically from 1 to 2; and x is specifically 1. It is understood that the platinum containing hydrosilylation catalyst can be composed of a single compound of Formula (1) or a mixture of compounds of Formula (1).

According to an embodiment of the invention a platinum containing hydrosilylation catalyst prepared by a process comprising:
i) mixing at least one platinum-complex containing at least one ligand which is substantially absent of tetrasiloxy units, and a polyorganosiloxane resin containing at least one monosiloxy unit possessing carbon-carbon double bond functionality and at least one tetrasiloxy unit; and
ii) exchanging a ligand of the platinum-complex containing at least one ligand with the polyorganosiloxane resin under exchange conditions to provide said platinum containing hydrosilylation catalyst.

According to an embodiment of the invention, the polyorganosiloxane resin containing at least one monosiloxy unit possessing carbon-carbon double bond functionality and at least one tetrasiloxy unit of the process has the general Formula (2):

MₐM^{vi}_{b}Q_{c} (2)

wherein:

each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;

each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;

each occurrence of Q is independently SiO_{4/2};

each occurrence of the subscripts a, b, c, and x is independently an integer wherein a is 0 to 200; b is 1 to 202; c is 1 to 100; and x is 1 to 3.

According to a specific embodiment of the invention, the platinum-complex containing at least one ligand which is substantially absent of tetrasiloxy units is a platinum-vinylsiloxane compound of the general Formula (3):

Pt₂(M^{vi}M^{vi})₃; (3)

wherein each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms.

In another specific embodiment, various hydrosilylation catalysts for effecting the addition of silicon hydride to vinyl-substituted silicon materials are known in the art and useful in the preparation of the novel catalyst of the present invention. For example, Karstedt, U.S. Pat. Nos. 3,715,334 and 3,775,452, discloses the use of Pt(0) complex with vinylsilicon siloxane ligands as an active hydrosilylation catalyst. Additional platinum complexes, such as, complexes with platinum halides are shown by Ashby, U.S. Pat. No. 3,159,601 and Lamoreaux, U.S. Pat. No. 3,220,972. Another hydrosilylation catalyst is shown by Fish, U.S. Pat. No. 3,576,027. Fish prepares a platinum(IV) catalyst by reacting crystalline platinum(IV) chloroplatinic acid and organic silane or siloxane to form a stable reactive platinum hydrosilylation catalyst. All of the aforementioned patents are herein incorporated by reference.

Other platinum Pt(0) and Pt(II) complexes which can be utilized in the practice of the present invention can have at least one ligand selected from the class consisting of halides, C₍₁₋₈₎ alkyl radicals, C₍₆₋₁₄₎ aryl radicals, C₍₁₋₈₎ aliphatically unsaturated organic radicals, nitriles and carbon monoxide. Some of these platinum complexes are for example, (1,5-cyclooctadiene)PtCl₂, [(C₂H₄)PtCl₂]₂, PtCl₂(CO)₂, PtCl₂(CH₃CN)₂, (1,5-cyclooctadiene )Pt(C₆H₅)₂, and (1,5-cyclooctadiene )Pt(CH₃) ₂.

The polyorganosiloxane resins, i.e., MₐM^{vi}_{b}Q, of the present invention can be prepared in a variety of ways. As such, the olefinically unsaturated organopolysiloxane containing at least one monosiloxy unit possessing carbon-carbon double bond functionality and at least one tetrasiloxy unit has the general Formula (2):

MₐM^{vi}_{b}Q_{c} (2)

wherein:

each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;

each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;

each occurrence of Q is independently SiO_{4/2};

each occurrence of the subscripts a, b, c, and x is independently an integer wherein a is 0 to 200; b is 1 to 202; c is 1 to 100; and x is 1 to 3.

The above olefinically unsaturated organopolysiloxanes include organopolysiloxanes which contain olefinic unsaturation by means of double bonds between two adjacent aliphatic carbon atoms. Among the radicals which R¹ and R³ represent are included alkyl, such as methyl, ethyl, propyl, isopropyl, butyl, octyl, dodecyl, and the like; cycloalkyl, such as cyclopentyl, cyclohexyl, cycloheptyl, and the like; aryl such as phenyl, naphthyl, tolyl, xylyl, and the like; aralkyl, such as benzyl, phenylethyl, phenylpropyl, and the like; halogenated derivatives of the aforesaid radicals including chloromethyl, trifluoromethyl, chloropropyl, chlorophenyl, dibromophenyl, tetrachlorophenyl, difluorophenyl, and the like; cyanoalkyl, such as beta-cyano ethyl, gamma-cyanopropyl, beta-cyanopropyl and the like.

According to an embodiment of the invention, R¹ is methyl, R² is vinyl and R³ is methyl.

The above olefinically unsaturated organopolysiloxanes resins are well known in the art, as particularly described by U.S. Pat. No. 3,344,111 to Chalk, and U.S. Pat. No. 3,436,366 to Modic, which are incorporated herein by reference. Similarly, their preparation and/or commercial availability are also well known.

Specific materials included within the scope of the olefinically unsaturated organopolysiloxanes resins are low molecular weight materials, such as, for example, octa(vinyldimethylsiloxy)tetracyclosiloxane, tetra(trimethylsiloxy)tetra(vinyldimethylsiloxy)tetracyclosiloxane, tetra(vinyldimethylsiloxy)silane, as well as higher polymers containing up to 30 or more silicon atoms per molecule. Also included within the scope of the olefinically unsaturated organopolysiloxanes are cyclic materials containing silicon-bonded vinyl or allyl radicals, such as the cyclic trimer, tetramer or pentamer of methylvinylsiloxane or methyl allylsiloxane.

In another embodiment of the invention, the polyorganosiloxane resin, i.e., MₐM^{vi}_{b}Q_{c}, (used to prepare the Examples disclosed herein) was prepared by the co-condensation of M^{vi}Cl, wherein M^{vi} is dimethylvinylsiloxy, with Si(OCH₂CH₃)₄ in the presence of water. The structure of the M^{vi}Q resin is (M^{vi}₂Q)₄.

According to an embodiment of the invention, the inventive catalyst of the present application can be prepared by exchanging the tetramethyldivinyldisiloxane (M^{vi}M^{vi}) ligand of the platinum-complex containing at least one least, and specifically the vinylsiloxane compound having the formula Pt₂(M^{vi}M^{v})₃, wherein M^{vi} is dimethylvinylsiloxy, i.e., Karstedt's catalyst. This preparation is achieved by mixing Karstedt's catalyst with an MₐM^{vi}_{b}Q_{c} resin, heating to achieve the exchange, and then distilling out the M^{vi}M^{vi} under vacuum. The new catalyst, Pt_{f}(MₐM^{vi}_{b}Q_{c})_{g}, is then isolated for the polymerization reaction. The catalyst may contain 0.1 to about 20 percent Pt by weight on an M^{vi}Q resin.

The concentration of Pt typically used to provide a thermally cured and solventless silicone release composition is from about 10 to about 250 ppm Pt.

In an alternative embodiment of the invention, the inventive Pt_{f}(MₐM^{vi}_{b}Q_{c})_{g} catalyst can be prepared directly from chloroplatinic acid, a common, commercially available material, and the desired MₐM^{vi}_{b}Q_{c} resin.

Optionally, the inventive catalyst may be prepared in the presence of both the MₐM^{vi}_{b}Q_{c} resin and vinyl-terminated silicone polymers, as disclosed herein. The vinyl-terminated silicone polymer may be present in minor amounts. The vinyl-terminated silicone polymer is comprised of a vinyl containing siloxane, which may be linear or branched with vinyl groups attached on a terminal, or internal silicone monomer group.

The following examples are given by way of indication and may not be regarded as a limitation on the scope and spirit of the invention.

### EXAMPLES

### Example 1

The catalyst of the invention was prepared as follows: 101.8 grams of a 10% by weight platinum, complexed as Karstedt's catalyst in a solution of M^{vi}M^{vi}, mixed with 100 grams of a M^{vi}Q resin containing 25% by weight of vinyl groups. The two were heated to 70° C. for two hours. The M^{vi}M^{vi} was then distilled to yield the PtₓM^{vi}Q catalyst of the invention.

### Examples 2-4

### Comparative Example 1

Example 2, 3 and 4 were prepared with 100 parts of a vinyl terminated polysiloxane of 250 ctks, 0.15 parts of Surfinol-61, 5.0 part of a methylhydrogen, dimethylsiloxane fluid having 1.05% hydrogen content, and 50 ppm by weight platinum of the PtM^{vi}Q catalyst were mixed together. Examples 2, 3 and 4 contained 1, 2 and 9 weight percent of the PtM^{vi}Q catalyst, respectively. The solution was then heated slowly (10° C./min) in a DSC instrument to record the reaction progress. Three measurements were take, temperature at the reaction onset, the temperature at the peak of reaction, and the temperature at which 95% of the reaction is complete. The results of which are presented in Table 1.

Similarly Comparative Example 1 was prepared using Karstedt's catalyst as a control reaction.

TABLE 1

| | Onset | Peak | Temperature at |
|---|---|---|---|
| | temperature, ° C. | temperature, ° C. | 95% reaction, ° C. |
| Example 2 | 75.715 | 79.866 | 85.422 |
| (1% PtM^{vi}Q) | | | |
| Example 3 | 69.931 | 78.800 | 81.814 |
| (2% PtM^{vi}Q) | | | |
| Example 4 | 70.959 | 74.833 | 79.721 |
| (9% PtM^{vi}Q) | | | |
| Comparative | 80.128 | 89.533 | 92.051 |
| Example 1 | | | |
| (Karstedt's | | | |
| catalyst) | | | |

The data presented in Table 1 demonstrates that the inventive catalyst starts the polymerization reaction at lower temperatures than the conventional catalyst. Further, as the reaction proceeds the peak reaction is attained by Examples 2-4 before and at lower temperatures than the Comparative Example 1. The polymerization reaction of Examples 2-4 reaches completion before and at lower temperatures than Comparative Example 1, i.e., the conventional catalyzed system.

### Example 5

By way of illustration without limiting the scope of the presently claimed invention, the inventive catalyst can be prepared by the method disclosed in U.S. Pat. No. 3,775,452, the entire contents of which is incorporated herein by reference. In this regard, the catalyst of the invention was prepared by placing 365 grams of M^{vi}Q resin, 365 grams of ethanol and 20 grams of chloroplatinic acid (H₂PtCl₆.6H₂O) in a flask and mixed by stirring. The solution was then heated to 50-55° C. for one hour. 41.7 grams of sodium carbonate was added and the reaction stirred and heated at 50-55° C. for one hour. The solution was cooled and the ethanol removed under vacuum. The solution was then filtered to remove the salts. The product contained 2% Platinum.

### Example 6

In an alternatively example, the catalyst of the invention was prepared by placing 365 grams of M^{vi}Q resin, 7.18 grams of M^{vi}M^{vi} resin, 365 grams of ethanol and 20 grams of chloroplatinic acid in a flask and mixed by stirring. The solution was then heated to 50-55° C. for one hour. 41.7 grams of sodium carbonate was added and the reaction stirred and heated for one hour at 50-55° C. The ethanol was removed under vacuum. The product was filtered to remove salts. The product contained 2% platinum.

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

1. A platinum containing hydrosilylation catalyst comprising at least one monosiloxy unit possessing carbon-carbon double bond functionality and at least one tetrasiloxy unit.

2. The platinum containing hydrosilylation catalyst of claim 1 wherein the catalyst has the formula:
Pt_{f}(MₐM^{vi}_{b}Q_{c})_{g}
wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;
each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;
each occurrence of Q is independently SiO_{4/2};
each occurrence of the subscripts a, b, c, f, g and x is independently an integer wherein a is 0 to 200; b is 1 to 202; c is 1 to 100; f is 1 to 100; g is 1 to 150; and x is 1 to 3.

3. The hydrosilylation catalyst of claim 2 wherein each occurrence of M is independently R¹₃ SiO_{1/2}, wherein each occurrence of R¹ is a monovalent hydrocarbon group containing from 1 to 6 carbon atoms, R² is an monovalent hydrocarbon group containing from 1 to 6 carbon atoms possessing at least one terminal carbon-carbon double bond, R³ is a monovalent hydrocarbon group containing from 1 to 6 carbon atoms, each a, b, c, f, g and x is an integer, wherein a from 0 to 10; b is from 2 to 15, c is from 2 to 10, f is from 1 to 2, g is from 1 to 4, and most specifically from 1 to 2; and x is 1.

4. The hydrosilylation catalyst of claim 2 wherein said catalyst is a single compound of said formula or a mixture of compounds of said formula.

5. The hydrosilylation catalyst of claim 2 wherein R¹ is methyl, R² is vinyl and R³ is methyl.

6. The hydrosilylation catalyst of claim 1 wherein said catalyst is a solid.

7. A platinum containing hydrosilylation catalyst prepared by a process comprising:
i) mixing at least one platinum-complex containing at least one ligand which is substantially absent of tetrasiloxy units, and a polyorganosiloxane resin containing at least one monosiloxy unit possessing carbon-carbon double bond functionality and at least one tetrasiloxy unit; and
ii) exchanging a ligand of the platinum-complex containing at least one ligand with the polyorganosiloxane resin under exchange conditions to provide said platinum containing hydrosilylation catalyst.

8. The process of claim 7 wherein the polyorganosiloxane resin has the formula:
MₐM^{vi}_{b}Q_{c}
wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;
each occurrence of M^{vi} is independently R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;
each occurrence of Q is independently SiO_{4/2};
each occurrence of the subscripts a, b, c, and x is independently an integer wherein a is 0 to 200; b is 1 to 202; c is 1 to 100; and x is 1 to 3.

9. The process of claim 7 wherein the platinum-complex containing at least one ligand has the formula:
Pt₂(M^{vi}M^{vi})₃;
wherein each occurrence of M^{vi} is independently R²ₓR³₃₋ₓ SiO_{1/2}, wherein each occurrence of R² is independently a monovalent hydrocarbon group containing from 1 to 30 carbon atoms possessing at least one unsaturated carbon-carbon double bond, each occurrence of R³ is a monovalent hydrocarbon group containing from 1 to 30 carbon atoms and each occurrence of x is from 1 to 3.

10. The process of claim 7 wherein the platinum containing hydrosilylation catalyst has the formula:
Pt_{f}(MₐM^{vi}_{b}Q_{c})_{g}
wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;
each occurrence of M^{vi} is independently R²R³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;
each occurrence of Q is independently SiO_{4/2};
each occurrence of the subscripts a, b, c, f, g and x is independently an integer wherein a is 0 to 200; b is 1 to 202; c is 1 to 100; f is 1 to 100; g is 1 to 150; and x is 1 to 3.

11. The process of claim 10 wherein each occurrence of M is independently R¹₃ SiO_{1/2}, wherein each occurrence of R¹ is a monovalent hydrocarbon group containing from 1 to 6 carbon atoms, R² is an monovalent hydrocarbon group containing from 1 to 6 carbon atoms possessing at least one terminal carbon-carbon double bond, R³ is a monovalent hydrocarbon group containing from 1 to 6 carbon atoms, each a, b, c, f, g and x is an integer, wherein a from 0 to 10; b is from 2 to 15, c is from 2 to 10, f is from 1 to 2, g is from 1 to 4, and most specifically from 1 to 2; and x is 1.

12. The process of claim 8 wherein the polyorganosiloxane resin is at least one selected from the group consisting of octa(vinyldimethylsiloxy)tetracyclosiloxane, tetra(trimethylsiloxy)tetra(vinyldimethylsiloxy)tetracyclosiloxane, tetra(vinyldimethylsiloxy)silane.

13. A thermally cured silicone release coating comprising a curing catalyst wherein the catalyst has the formula:
Pt_{f}(MₐM^{vi}_{b}Q_{c})_{g}
wherein:
each occurrence of M is independently selected from the group consisting of R¹₃ SiO_{1/2}, HO_{1/2}, and R¹O_{1/2} and wherein each occurrence of R¹ is independently a monovalent hydrocarbon group containing from 1 to 30 carbon atoms;
each occurrence of M^{vi} is independently given by R²ₓR³₃₋ₓ SiO_{1/2} wherein each occurrence of R² is independently a monovalent hydrocarbon group containing from 1 to 30 carbon atoms possessing at least one unsaturated carbon-carbon double bond and each occurrence of R³ is a monovalent hydrocarbon group containing from 1 to 30 carbon atoms;
each occurrence of Q is independently given by SiO_{4/2};
each occurrence of the subscripts a, b, c, f, g and x is independently an integer wherein a is 0 to 200; b is 1 to 202; c is 1 to 100; f is 1 to 100; g is 1 to 150; and x is 1 to 3.
